(19) United States
(12) Patent Application Publication
(10) Pub. No.: US 2014/0056468 A1
(43) Pub. Date: Feb. 27, 2014

(54) MAGNETIC CIRCUIT FOR LOUDSPEAKER AND LOUDSPEAKER USING THE SAME

(71) Applicants: Mitsukazu Kuze, Mie (JP); Satoshi Koura, Mie (JP); Goro Tsuchiya, Mie (JP); Tetsushi Itano, Mie (JP)

(72) Inventors: Mitsukazu Kuze, Mie (JP); Satoshi Koura, Mie (JP); Goro Tsuchiya, Mie (JP); Tetsushi Itano, Mie (JP)

(73) Assignee: Panasonic Corporation, Osaka (JP)

(21) Appl. No.: 13/983,773

(22) PCT Filed: Jan. 15, 2013
(86) PCT No.: PCT/JP2013/000115

§ 371 Date: Aug. 6, 2013

(30) Foreign Application Priority Data
Jan. 20, 2012 (JP) 2012-009870
Jan. 31, 2012 (JP) 2012-017683
Feb. 22, 2012 (JP) 2012-035890
Feb. 22, 2012 (JP) 2012-035891

(51) Int. Cl. H04R 3/00

(52) U.S. Cl. CPC H04R 3/00
USPC 381/414

(57) ABSTRACT

A magnetic circuit for a loudspeaker includes a magnet and a top plate. The magnet is made of a bonded magnet. The magnet and the top plate are configured to satisfy at least one of conditions that an inner diameter of the magnet is identical to an inner diameter of the top plate, and that an outer diameter of the magnet is identical to an outer diameter of the top plate. This configuration eliminates a wasted space inside the magnetic circuit, and protrusion of the magnet to outside, hence providing a light and efficient magnetic circuit.

### TECHNICAL FIELD

The present invention relates to a magnetic circuit for a loudspeaker and a loudspeaker using the magnetic circuit that is employed in products for vehicles, video, audio, and mobile communications.

### BACKGROUND ART

FIGS. 32 and 33 are sectional views of a conventional magnetic circuit for loudspeaker. Conventionally, the magnetic circuit includes a magnet and at least a top plate.

Outer-magnet-type magnetic circuit 4 shown in FIG. 32 further includes bottom plate 3 in addition to magnet 1 and top plate 2.

Inner-magnet-type magnetic circuit 4A shown in FIG. 33 further includes yoke 3A in addition to magnet 1A and top plate 2A.

Magnetic gaps 5 and 5A are magnetic spaces where a voice coil inserted therein vertically vibrates upon receiving a magnetic force when magnetic circuit 4 or 4A is used in a loudspeaker. Magnetic gaps 5 and 5A are parts that require extremely high accuracy. Dimensions of magnetic gaps 5 and 5A and vertical dimensions of magnetic gaps 5 and 5A need to be secured.

Therefore, processing, such as cutting work, for increasing accuracy is applied to top plates 2 and 2A that configure magnetic gaps 5 and 5A and parts of bottom plates 3 and 3A that correspond to magnetic gaps 5 and 5A. This increases the dimensional accuracy of magnetic gaps 5 and 5A.

On the other hand, magnets 1 and 1A are made by sintering both outer and inner magnet types. However, the sintering is a manufacturing method unstable for dimensions. Therefore, processing, such as cutting work, for increasing accuracy is applied in the thickness direction of magnets 1 and 1A that need to be connected with other components of the magnetic circuit. However, since post-processing, such as cutting work, is difficult to be applied to the inner diameter and outer diameter of magnets 1 and 1A, cutting work is not applied. Accordingly, the accuracy of inner diameter and outer diameter of magnets 1 and 1A are extremely poor.

Taking into account an allowance and accuracy of assembly, it is necessary to provide a large dimensional allowance to secure vertical dimensions of magnetic gaps 5 and 5A in order to avoid interference of the voice coil with magnets 1 and 1A during vertical vibrations of the voice coil, even if the dimensional accuracy of the magnet is extremely poor.

In outer-magnet-type magnetic circuit 4, the inner diameter of magnet 1 is extremely larger than the inner diameter of top plate 2. To secure the volume of magnet 1, the outer diameter of magnet 1 protrudes toward the outside of the outer diameter of top plate 2.

On the other hand, in inner magnet type magnetic circuit 4A, the outer diameter of magnet 1A is extremely smaller than the outer diameter of top plate 2A. This configuration reduces the volume of magnet 1A.

These structures create large space inside magnetic circuits 4 and 4A, so as to offset variations in dimensional accuracy or poor assembly accuracy of magnets 1 and 1A.

In this way, dimensions of magnetic gaps 5 and 5A and vertical dimensions of magnetic gaps 5 and 5A are secured against variations in dimensional accuracy or poor assembly accuracy of magnets 1 and 1A. This prevents gap failure due to contact of the voice coil with magnets 1 and 1A.

### CITATION LIST

### Patent Literature

Patent Literature 1: Japanese Patent Laid-Open Publication No. 2000-224695

Patent Literature 2: Japanese Patent Laid-Open Publication No. 2003-9284

Patent Literature 3: Japanese Patent Laid-Open Publication No. 2003-9285

### SUMMARY OF THE INVENTION

The present invention may provide a smaller, thinner and lighter magnetic circuit for a loudspeaker by eliminating a wasted space inside the magnetic circuit caused by poor dimensional accuracy of a sintered magnet.

To solve the above problem, a loudspeaker of the present invention includes a magnet and at least a top plate. The magnet is made of a bonded magnet. The magnet and the top plate are configured to satisfy at least one of conditions that the inner diameter of the magnet is identical to the inner diameter of the top plate, and that the outer diameter of the magnet is identical to the outer diameter of the top plate.

The shapes of the magnet and the top plate depend on the structure of the magnetic circuit, i.e., an outer magnet type or an inner magnet type. The magnet and the top plate of the outer-magnet-type magnetic circuit often have a ring shape having inner and outer diameters. On the other hand, in the inner-magnet-type magnetic circuit, the magnet and the top plate often have columnar shapes, and therefore have an outer diameter only.

The shapes of the magnet and the top plate often have rectangular shapes, circular shapes, racetrack shapes, or oval shapes for both outer diameter and inner diameter. However, any shape is acceptable.

By forming the magnet with a bonded magnet, a bonded magnet with good dimensional accuracy can be obtained, using injection molding. Better dimensional accuracy of the inner diameter and outer diameter of the magnet allows the same dimensions to be set for the magnet and the top plate. An efficient magnetic circuit can thus be achieved by eliminating wasted space inside the magnetic circuit.

In addition, depending on the structure of the magnetic circuit, a protrusion of the magnet toward the outside can be eliminated to both downsize the loudspeaker and improve magnetic efficiency.

Furthermore, the specific gravity of a bonded magnet can be lower than that of a conventional magnet according to the proportion of resin. A lighter magnetic circuit can thus be achieved.

The above structure prevents a gap failure, improves magnetic efficiency, and provides a smaller, thinner and lighter magnetic circuit.

### BRIEF DESCRIPTION OF DRAWINGS

FIG. 1 is a sectional view of a magnetic circuit for a loudspeaker in accordance with an exemplary embodiment of the present invention.

FIG. 2 is a plan view of the magnetic circuit in accordance with the embodiment of the invention.

FIG. 3 is a sectional view of a magnetic circuit for a loudspeaker in accordance with the embodiment of the invention.

FIG. 4 is a sectional view of a magnetic circuit for a loudspeaker in accordance with the embodiment of the invention.

FIG. 5 is a sectional view of a magnetic circuit for a loudspeaker in accordance with the embodiment of the invention.

FIG. 6 is a sectional view of a magnetic circuit for a loudspeaker in accordance with the embodiment of the invention.

FIG. 7 is a sectional view of a magnetic circuit for a loudspeaker in accordance with the embodiment of the invention.

FIG. 8 is a sectional view of a magnetic circuit for a loudspeaker in accordance with the embodiment of the invention.

FIG. 9 is a sectional view of a magnetic circuit for a loudspeaker in accordance with the embodiment of the invention.

FIG. 10 is a sectional view of a magnetic circuit for a loudspeaker in accordance with the embodiment of the invention.

FIG. 11 is a sectional view of a magnetic circuit for a loudspeaker in accordance with the embodiment of the invention.

FIG. 12 is a sectional view of a magnetic circuit for a loudspeaker in accordance with the embodiment of the invention.

FIG. 13 is a sectional view of a magnetic circuit for a loudspeaker in accordance with the embodiment of the invention.

FIG. 14 is a sectional view of a magnetic circuit for a loudspeaker in accordance with the embodiment of the invention.

FIG. 15 is a sectional view of a magnetic circuit for a loudspeaker in accordance with the embodiment of the invention.

FIG. 16 is a sectional view of a magnetic circuit for a loudspeaker in accordance with the embodiment of the invention.

FIG. 17 is a sectional view of a magnetic circuit for a loudspeaker in accordance with the embodiment of the invention.

FIG. 18 is a sectional view of a magnetic circuit for a loudspeaker in accordance with the embodiment of the invention.

FIG. 19 is a sectional view of a magnetic circuit for a loudspeaker in accordance with the embodiment of the invention.

FIG. 20 is a sectional view of a magnetic circuit for a loudspeaker in accordance with the embodiment of the invention.

FIG. 21 is a sectional view of a magnetic circuit for a loudspeaker in accordance with the embodiment of the invention.

FIG. 22 is a sectional view of a magnetic circuit for a loudspeaker in accordance with the embodiment of the invention.

FIG. 23 is a sectional view of a magnetic circuit for a loudspeaker in accordance with the embodiment of the invention.

FIG. 24 is a sectional view of a magnetic circuit for a loudspeaker in accordance with the embodiment of the invention.

FIG. 25 is a sectional view of a magnetic circuit for a loudspeaker in accordance with the embodiment of the invention.

FIG. 26 is a sectional view of a magnetic circuit for a loudspeaker in accordance with the embodiment of the invention.

FIG. 27 is a sectional view of a magnetic circuit for a loudspeaker in accordance with the embodiment of the invention.

FIG. 28 is a sectional view of a magnetic circuit for a loudspeaker in accordance with the embodiment of the invention.

FIG. 29 is a sectional view of the magnetic circuit for a loudspeaker in accordance with the embodiment of the invention.

FIG. 30 is a sectional view of a loudspeaker in accordance with the embodiment of the invention.

FIG. 31 is a sectional view of the loudspeaker in accordance with the embodiment of the invention.

FIG. 32 is a sectional view of a conventional magnetic circuit for a loudspeaker.

FIG. 33 is a sectional view of a conventional magnetic circuit for a loudspeaker.

### DETAIL DESCRIPTION OF PREFERRED EMBODIMENT

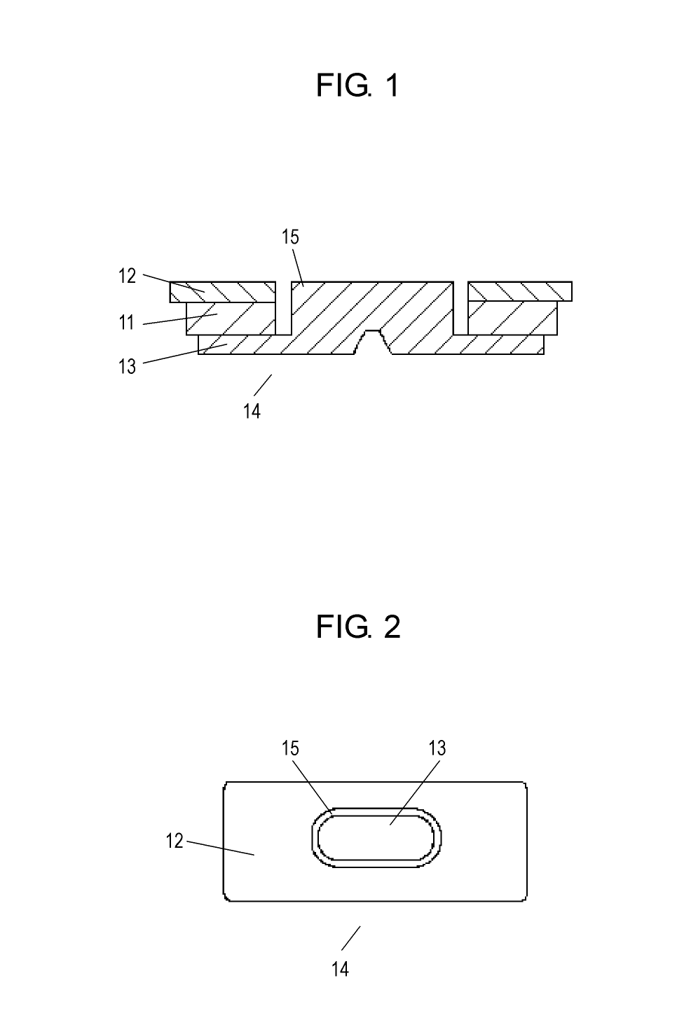

FIGS. 1 to 29 are sectional views and plan views of magnetic circuits for a loudspeaker according to exemplary embodiment of the present invention.

FIGS. 1 to 19 are sectional views and plan views of outer-magnet-type magnetic circuits for a loudspeaker according to the embodiment of the invention. FIGS. 20 to 29 are sectional views of inner-magnet-type magnetic circuits for a loudspeaker according to the embodiment of the present invention.

FIG. 1 is a sectional view of a slim magnetic circuit. As shown in FIG. 2, a plan view of the magnetic circuit, the magnetic circuit has a rectangular outer shape and a magnetic gap having a racetrack shape.

However, the present invention is not limited to this shape. The magnetic circuit may have a circular outer shape or a circular magnetic gap. These shapes also provide the same effect. As shown in FIGS. 1 and 2, magnet 11 is sandwiched between top plate 12 and bottom plate 13 to configure outer-magnet-type magnetic circuit 14 for loudspeaker.

Magnetic gap 15 is a magnetic space in which a voice coil inserted vertically vibrates upon receiving a magnetic force when this magnetic circuit 14 is used in a loudspeaker. This is a part that requires extremely high accuracy.

In this magnetic circuit 14, magnet 11 is made of a bonded magnet. An inner diameter of top plate 12 is identical to an inner diameter of magnet 11.

This structure eliminates a wasted space inside magnetic circuit 14, and thus, the inner diameter of magnet 11 can be as small as possible. This reduces the outer diameter of magnet 11. As a result, a magnet with the same magnetic energy can be downsized. Small magnet 11 improves efficiency and reduces the size of magnetic circuit 14.

Depending on a required shape of the magnetic circuit, a thinner, instead of smaller, magnetic circuit can be designed. Furthermore, a smaller and thinner magnetic circuit can be balanced to design a magnetic circuit that satisfies market demands.

Magnet 11 that is a bonded magnet made of a mixture of resin and magnetic metal has a smaller specific gravity than a conventional sintered ferrite magnet, depending on the proportion of resin mixed, accordingly providing significantly lighter magnet 11.

A dimensional accuracy of magnet 11 made of the bonded magnet will be described below. Magnet 11 is the bonded magnet, and is made by injection-molding a mixture material of resin and magnetic metal.

The dimensional accuracy of this magnet 11 depends mostly on the dimensional accuracy of molds used for the injection molding. Although there is a slight variation in pressure or temperature at injection molding, the dimensional accuracy of the molds is a dominant factor on the whole. Therefore, the bonded magnet can ensure good quality with extremely high dimensional accuracy by increasing the dimensional accuracy of the molds for injection molding. The bonded magnet has higher dimensional accuracy than ferrite magnet made by a conventional sintering process.

The inner diameter of top plate 12 can be identical to the inner diameter of magnet 11 by using this high dimensional accuracy.

This is because, in general, the inner diameter of top plate 12 and the outer diameter of center pole of bottom plate 13 are positioned by a gap gauge on assembling magnetic circuit 14. In addition, this gap gauge further extending to the lower side simultaneously positions the inner diameter of magnet 11. This secures a dimension of magnetic gap 15 all the way down, so as to prevent the inner diameter of magnet 11 from projecting into magnetic gap 15.

This structure can prevent disturbance of vertical vibration of the voice coil in magnetic gap 15 and its lower side when magnetic circuit 14 is used in a loudspeaker, and eliminate occurrence of a gap failure.

As described above, a wasted space inside magnetic circuit 14 can be eliminated and the inner diameter of magnet 11 can be reduced as much as possible by allowing the inner diameter of top plate 12 to be identical to the inner diameter of magnet 11. This also reduces the outer diameter of magnet 11. As a result, a magnet with same magnetic energy can have a small size. Small magnet 11 can provide more efficient and smaller magnetic circuit 14.

Accordingly, the present invention can provide a magnetic circuit for a loudspeaker that satisfies the market demand for a smaller, thinner and lighter magnetic circuit, and a loudspeaker configured using this magnetic circuit.

The example having a structure in which the inner diameter of top plate 12 is identical to the inner diameter of magnet 11. Another example will be described below.

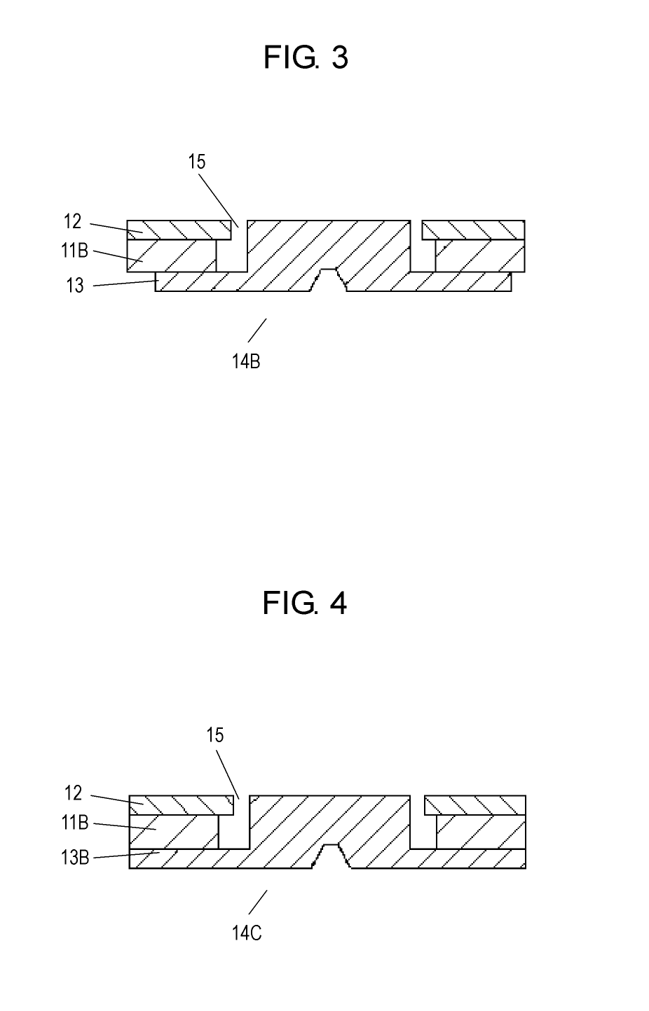

As shown in FIG. 3, magnetic circuit 14B for a loudspeaker is configured such that the outer diameter of top plate 12 is identical to the outer diameter of magnet 11B. This structure configures magnetic circuit 14B in which the outer diameter of magnet 11B, which is conventionally larger than the outer diameter of top plate 12, is identical to the outer diameter of top plate 12.

This can be provided by a bonded magnet that can increase the dimensional accuracy. This structure avoids reduction of magnetic efficiency due to the outer diameter of magnet 11B projecting inward more than the outer diameter of top plate 12. The outer diameter of magnet 11B can thus be reduced. Small magnet 11B can provide more efficient and smaller magnetic circuit 14B.

Accordingly, a magnetic circuit for a loudspeaker that satisfies the market demand for a smaller, thinner and lighter magnetic circuit can be achieved.

Further, as shown in FIG. 4, magnetic circuit 14C for a loudspeaker may be configured such that the outer diameter of bottom plate 13B is identical to the outer diameter of magnet 11B. This structure configures magnetic circuit 14C in which the outer diameter of magnet 11B, which is conventionally larger than the outer diameter of bottom plate 13B, is identical to the outer diameter of bottom plate 13B. This structure avoids reduction of magnetic efficiency due to the outer diameter of magnet 11B projecting inward more than the outer diameter of bottom plate 13B. The outer diameter of magnet 11B can thus be reduced. Small magnet 11B can provide more efficient and smaller magnetic circuit 14C.

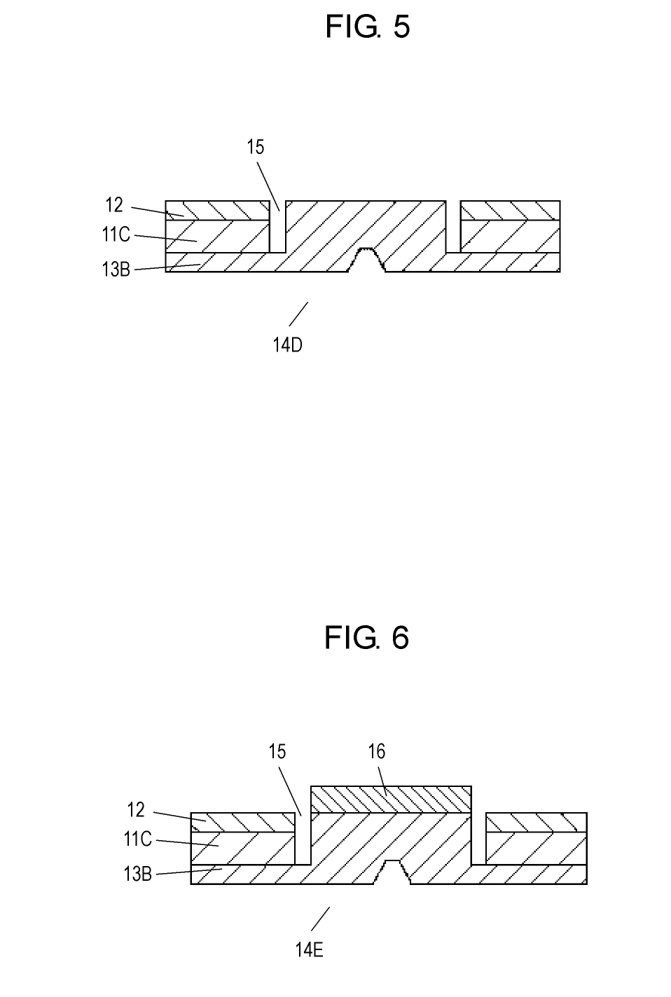

Furthermore, as shown in FIG. 5, the outer diameters of components of magnetic circuit 14D have dimensions shown in FIG. 4, and the inner diameters of components of magnetic circuit 14D may have the dimensions shown in FIG. 1. In other words, magnetic circuit 14D for a loudspeaker may be configured such that the outer diameters of components of the magnetic circuit are identical to each other and the inner diameters of components of the magnetic circuit are identical to each other. This structure further reduces the outer diameter of magnet 11C. Small magnet 11C can provide more efficient and smaller magnetic circuit 14D.

Next, an example further including a repulsion magnet with different magnetization direction provided on a center pole of bottom plate 13B so as to provide a smaller size and higher efficiency will be described below.

As shown in FIG. 6, repulsion magnet 16 with a different magnetization direction is provided on the center pole of bottom plate 13B. Repulsion magnet 16 is made of a bonded magnet. The outer diameter of this repulsion magnet 16 is identical to the outer diameter of the center pole to configure magnetic circuit 14E for a loudspeaker. This structure can increase a magnetic flux density in magnetic gap 15 due to repulsion magnet 16 with the different magnetization direction provided on the center pole. Accordingly, to obtain the same magnetic flux density in the magnetic gap, the overall dimensions of the magnetic circuit can be reduced, hence providing more efficient and smaller magnetic circuit 14E. Furthermore, when the magnetic circuit is used in a loudspeaker, this structure can eliminate a wasted space inside the loudspeaker surrounded by the upper part of the center pole of magnetic circuit 14E, a voice coil, and a dust cap.

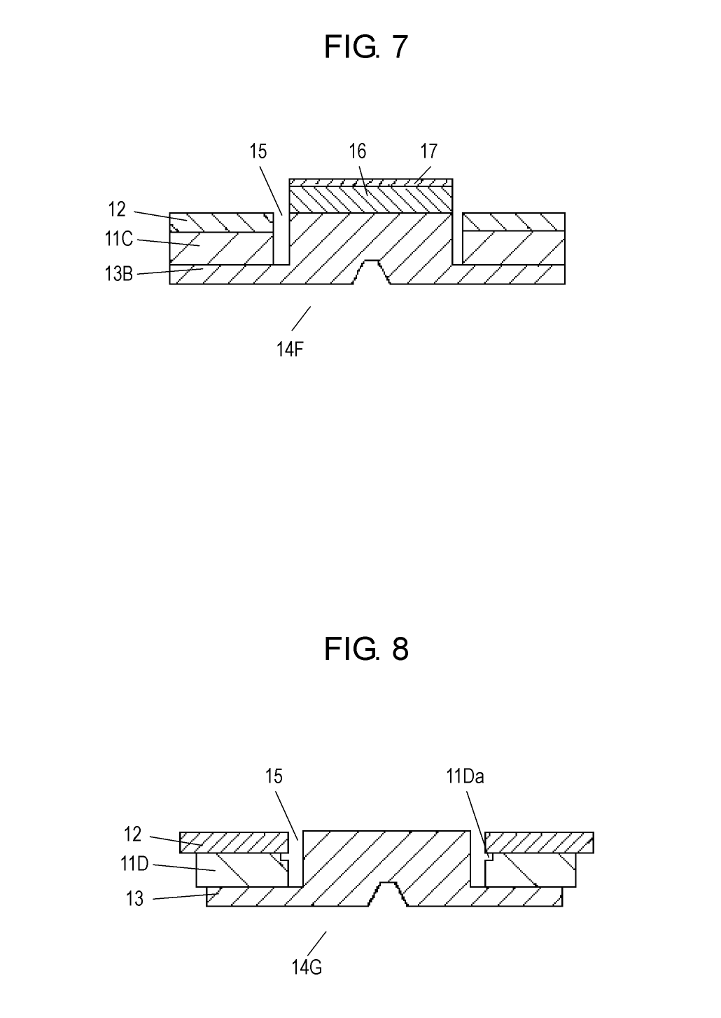

Furthermore, as shown in FIG. 7, sub-plate 17 may be provided on repulsion magnet 16. The outer diameter of this repulsion magnet 16 is identical to the outer diameter of sub-plate 17. This structure can prevent a magnetic flux of repulsion magnet 16 with a different magnetization direction, which is provided on the center pole, from leaking in the direction opposite to magnetic gap 15. Concentrating of the magnetic flux on magnetic gap 15 increases the magnetic flux density in magnetic gap 15. Accordingly, to obtain the same magnetic flux density in the magnetic gap, the overall dimensions of the magnetic circuit can be further reduced, thus providing efficient and smaller magnetic circuit 14F. Furthermore, when the magnetic circuit is used in a loudspeaker, this structure can eliminate a wasted space inside the loudspeaker surrounded by the upper part of the center pole of magnetic circuit 14F, a voice coil, and a dust cap.

As described above, a magnetic circuit further including repulsion magnet 16 with a different magnetization direction and sub-plate 17 has a disadvantage with respect to a lighter magnetic circuit since components of repulsion magnet 16 and sub-plate 17 are added, but the magnetic efficiency improves more than this disadvantage. Accordingly, to obtain the same magnetic flux density in the magnetic gap, the magnetic circuit can be lighter, and the overall dimensions of the magnetic circuit can be reduced.

Next, materials of the top plate, the bottom plate, and the sub-plate used in this magnetic circuit will be described with reference to FIGS. 1 and 7. Top plate 12, bottom plate 13, and sub-plate 17 may often be made of metal material of iron similarly to those of the prior art. However, top plate 12, bottom plate 13, and sub-plate 17 may be made of a mixture of magnetic metal and resin. By injection-molding the mixture of magnetic metal and resin to form top plate 12, bottom plate 13, and sub-plate 17, the dimensional accuracy can be increased, similarly to the aforementioned bonded magnet. In addition, a specific gravity can be smaller for the proportion of resin, than conventional plates formed of metal materials, significantly reducing the weight. Accordingly, the combination of top plate 12, bottom plate 13, and sub-plate 17 with aforementioned bonded magnet can provide a drastically lighter magnetic circuit.

To manufacture these top plate 12 and bottom plate 13, the mixture of magnetic metal and resin is injection-molded. More efficient magnetic circuit 14 can be achieved by allowing a mixing ratio of the magnetic metal to be higher locally near the inner circumference of top plate 12 than other positions of the magnetic circuit, or by allowing the mixing ratio of the magnetic metal to be higher locally near the outer circumference of the center pole of bottom plate 13 than other positions of the magnetic circuit. The higher mixing ratio of magnetic metal locally near magnetic gap 15 of top plate 12 or bottom plate 13 can provide an efficient magnetic circuit. To obtain the same magnetic flux density in the magnetic gap, a smaller or thinner magnetic circuit can be achieved.

A method of coupling components of magnetic circuit 14 for a loudspeaker will be described below. The components configuring magnetic circuit 14 for a loudspeaker are bonded with adhesive to establish secure connection. This can keep the good state with respect to quality and reliability. In this case, the adhesive may preferably selected to firmly bond magnetic metal or resin.

On the other hand, joint areas of the components may be melted and adhered to each other to configure the magnetic circuit without using an adhesive. In this case, since the joint areas of the components are melted to adhere, an adhesive is not needed, and can eliminate the thickness of the adhesive, accordingly reducing the thickness of the magnetic circuit. Ultrasonic waves for thermal melting allow the magnetic circuit to be manufactured at good productivity. In addition, the joint areas may be melted and adhered using solvent. This can eliminate a heat source, such as the ultrasonic waves. In addition to good productivity, this method of adhering for the magnetic circuit reduces cost, such as equipment and electric energy costs.

As described above, the magnetic circuit configured by melting and adhering the joint areas of the components without using an adhesive can provide a significant synergetic effect by also configuring a part or all of magnet 11, top plate 12, bottom plate, 13 and sub-plate 17, which are components of the magnetic circuit, with a mixture of magnetic metal and resin. This provides a thinner magnetic circuit with higher productivity.

Next, an effective structure will be described below in which the method of coupling the components of the magnetic circuit for a loudspeaker is adhesive bonding using adhesive or attachment by melting the joint areas of the components.

When the joint areas of the components are adhered with an adhesive or by melting, the dimensional accuracy or quality can be improved by eliminating a protrusion of adhesive or a protrusion of the melted portion from the joint areas.

For this purpose, the magnet is made of a bonded magnet in the magnetic circuit for a loudspeaker shown in FIGS. 8 to 19, and the inner diameter of the top plate is identical to the inner diameter of the magnet. In addition, a part or all of the magnet, the top plate, and the bottom plate have a recess therein.

In other words, in magnetic circuit 14G shown in FIG. 8, magnet 11D is made of a bonded magnet, and the inner diameter of top plate 12 is identical to the inner diameter of magnet 11D. In addition, recess 11Da is provided in an inner upper surface of magnet 11D.

In this structure, recess 11Da provides an escape for an adhesive sticking out from bonding magnet 11D and top plate 12 adhered with the adhesive. Any excessive adhesive is collected in recess 11Da, and thus, prevents the adhesive from protruding into magnetic gap 15, thus preventing a gap failure due to the protrusion of the adhesive.

Also when the joint areas of the components are melted to adhere, recess 11Da provides an escape for the melted portions sticking out from a part of the melted portions that is melted magnet 11D or melted top plate 12. Any excessive melted portion is collected in recess 11Da, and thus, is prevented from protruding into magnetic gap 15, thus preventing a gap failure due to partial protrusion of melted portion.

Next, another example will be described.

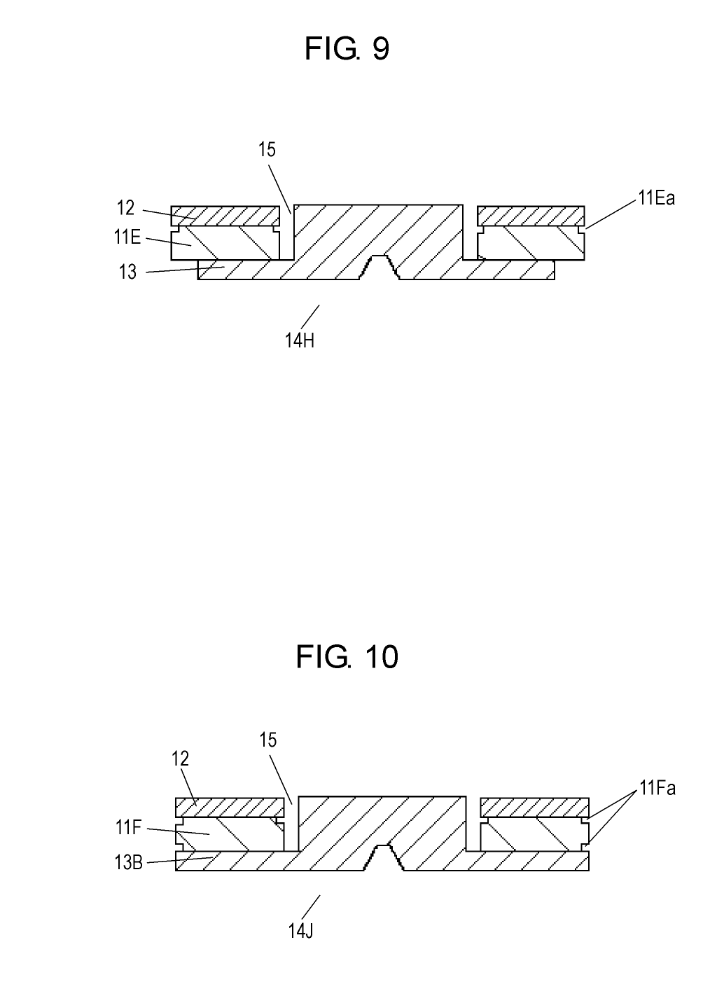

FIG. 9 shows magnetic circuit 14 for a loudspeaker in which the outer diameter of top plate 12 is identical to the outer diameter of magnet 11E, in addition to the structure shown in FIG. 8, and recess 11Ea is provided in an outer upper surface of magnet 11E.

This structure configures magnetic circuit 14H in which the outer diameter of magnet 11E, which is conventionally larger than the outer diameter of top plate 12, is identical to the outer diameter of top plate 12 since the bonded magnet used for magnet 11E has high dimensional accuracy.

Still more, recess 11Ea can prevent a protrusion of the adhesive to outside of magnetic circuit 14H in addition to prevention of occurrence of gap failure due to the protrusion of the adhesive. Accordingly, a high-quality magnetic circuit for loudspeaker can be achieved.

The above structure can reduce the outer diameter of magnet 11E. Small magnet 11E can thus provide more efficient and smaller magnetic circuit 14H.

As described above, the present invention can offer a high-quality magnetic circuit for a loudspeaker that can satisfy the market demand for smaller, thinner, and lighter magnetic circuits and loudspeakers using this magnetic circuit.

As shown in FIG. 10, the outer diameter of bottom plate 13B may be identical to the outer diameter of magnet 11F, and recess 11Fa may be provided in an outer lower surface of magnet 11F to configure magnetic circuit 14J for a loudspeaker.

Recess 11Fa can prevent a protrusion of the adhesive to an outside of magnetic circuit 14J in addition to prevention of occurrence of the gap failure due to the protrusion of the adhesive. Accordingly, a high-quality magnetic circuit for loudspeaker can be achieved.

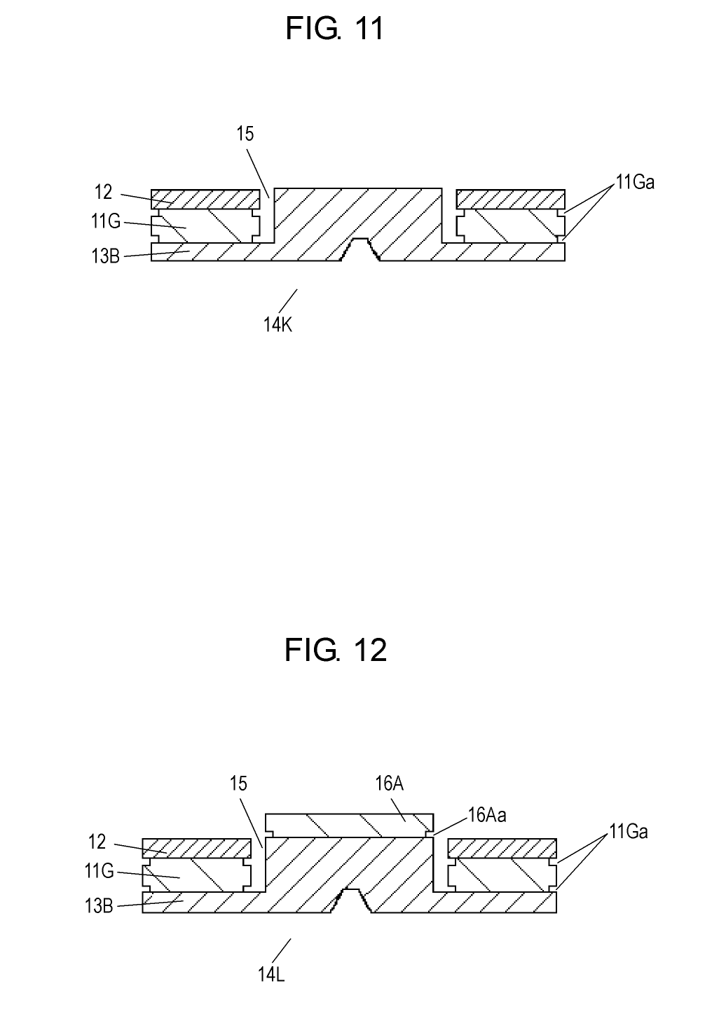

Furthermore, in addition to the structure shown in FIG. 10, the inner diameters of top plate 12 and bottom plate 13B may be identical to the inner diameter of magnet 11G, and the outer diameters of top plate 12 and bottom plate 13B may be identical to the outer diameter of magnet 11G, as shown in FIG. 11. Recess 11Ga may be provided in an inner lower surface to configure magnetic circuit 14K for a loudspeaker.

This structure can prevent a gap failure due to a protrusion of the adhesive to the inner side of magnet 11G and bottom plate 13B, in addition to the aforementioned effect.

The above description refers to structures of outer-magnet-type magnetic circuits. To further downsize and improve efficiency, next is described an embodiment in which repulsion magnet with different magnetization direction is provided on an upper part of the center pole of the bottom plate.

As shown in FIG. 12, repulsion magnet 16A with a different magnetization direction may be provided on the center pole of bottom plate 13B, in addition to the above description. The outer diameter of repulsion magnet 16A is identical to the outer diameter of the center pole, and recess 16Aa is provided in an outer lower surface of repulsion magnet 16A to configure magnetic circuit 14L for a loudspeaker.

This structure can increase the magnetic flux density in magnetic gap 15 by the effect of repulsion magnet 16A with the different magnetization direction provided on the center pole.

Accordingly, to obtain the same magnetic flux density in the magnetic gap, the overall dimensions of the magnetic circuit can be reduced.

In addition, this structure prevents the gap failure that may occur due to a protrusion of an adhesive to repulsion magnet 16A and an outside of the center pole of bottom plate 13B.

Accordingly, more efficient and smaller magnetic circuit 14 can be achieved. Still more, a wasted space inside the loudspeaker surrounded by the upper part of the center pole of magnetic circuit 14L, a voice coil, and a dust cap can be eliminated when magnetic circuit 14L is used for a loudspeaker.

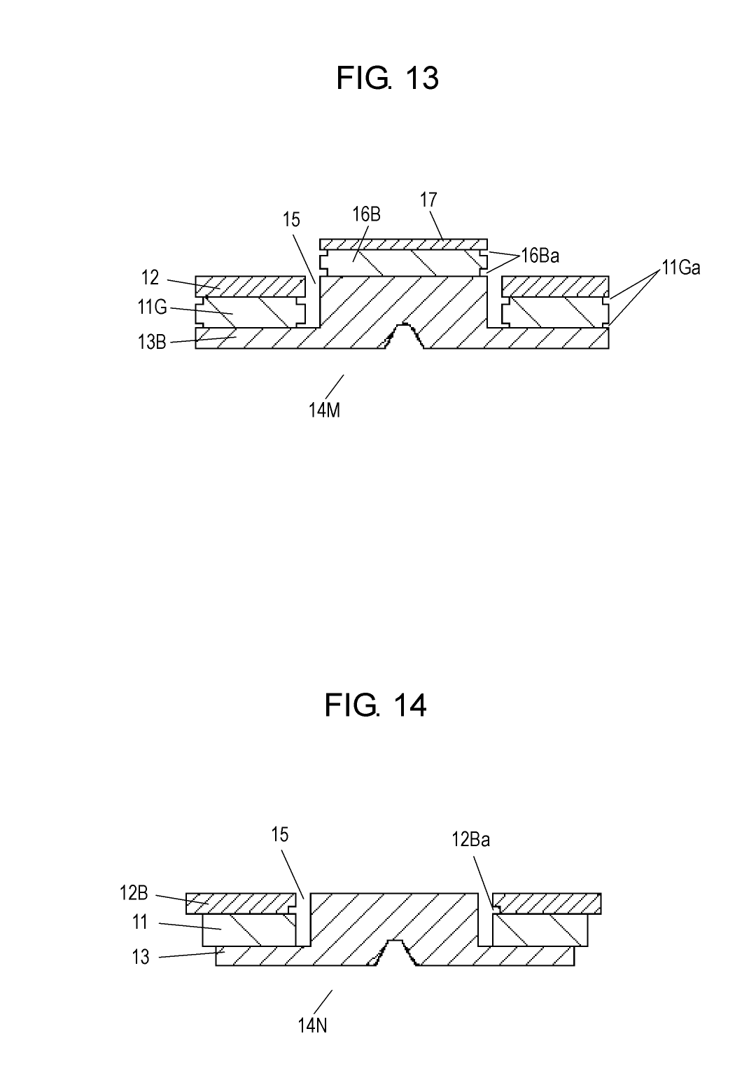

Furthermore, as shown in FIG. 13, sub-plate 17 may be provided on repulsion magnet 16B in which the outer diameter of repulsion magnet 16B is identical to the outer diameter of sub-plate 17, and recess 16Ba may be provided in the outer upper surface of repulsion magnet 16B to configure magnetic circuit 14M for a loudspeaker.

This structure can prevent magnetic flux of repulsion magnet 16B with the different magnetization direction, which is provided on the center pole, from leaking in a direction opposite to magnetic gap 15. An effect of concentrating magnetic flux toward magnetic gap 15 can further increase the magnetic flux density in magnetic gap 15.

Accordingly, to obtain the same magnetic flux density in the magnetic gap, the overall dimensions of the magnetic circuit can be further reduced.

Still more, an operating point of magnetic circuit 14M can be improved. This achieves high quality and high reliability also with respect to ambient temperature characteristics, such as demagnetization at high temperatures and demagnetization at low temperatures.

Accordingly, further efficient and smaller magnetic circuit 14M can be provided. In addition, when magnetic circuit 14M is used for a loudspeaker, a wasted space inside the loudspeaker surrounded by the center pole of magnetic circuit 14M, a voice coil, and a dust cap can be eliminated.

As described above, the magnetic circuit further including repulsion magnet 16A or 16B with a different magnetization direction and sub-plate 17 has a disadvantage with respect to a lighter magnetic circuit since components of repulsion magnet 16A or 16B and sub-plate 17 are added, but the magnetic efficiency improves more than this disadvantage. Accordingly, to obtain the same magnetic flux density in the magnetic gap, the magnetic circuit can be made lighter, and the overall dimensions of the magnetic circuit can thus be reduced.

Next, top plate 12, bottom plate 13, and sub-plate 17 used in this magnetic circuit will be detailed below.

As shown in FIGS. 14 to 19, a recess may be provided in the top plate, the bottom plate, or the sub-plate.

As shown in FIG. 14, top plate 12B is configured by injection-molding a mixture of magnetic material and resin. Recess 12Ba is provided in the inner lower surface of top plate 12B to configure magnetic circuit 14N for a loudspeaker.

In this structure, recess 12Ba provides an escape for the adhesive to prevent a protrusion of the adhesive to the inner side of magnet 11 and top plate 12B, similarly to the recess is provided in aforementioned magnet. Accordingly, gap failure due to protrusion of adhesive can be prevented.

To form recess 12Ba, a cutting work in a process is not necessary, which is the case of a plate formed of conventional metal material. A mold having a recess may be simply used to easily form a recess by injection-molding, thus improving productivity.

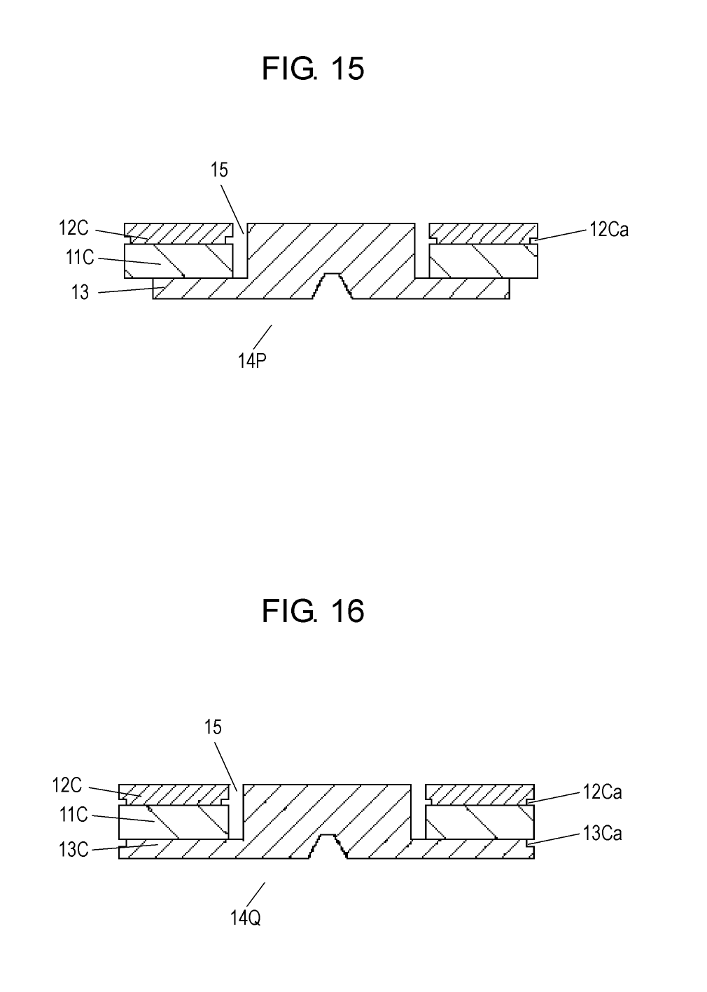

As shown in FIG. 15, the outer diameter of top plate 12C is identical to the outer diameter of magnet 11C, in addition to the structure shown in FIG. 14. Recess 12Ca is also provided in the outer lower surface of top plate 12C to configure magnetic circuit 14P for a loudspeaker.

This structure can also provide an escape for the adhesive, similarly to above, thus preventing a protrusion of the adhesive.

As shown in FIG. 16, the outer diameter of bottom plate 13C is identical to the outer diameter of magnet 11C, in addition to the structure shown in FIG. 15. Recess 13Ca is provided in the outer upper surface of bottom plate 13 to configure magnetic circuit 14Q for a loudspeaker.

This structure can also provide an escape for the adhesive, similarly to above, thus preventing a protrusion of the adhesive.

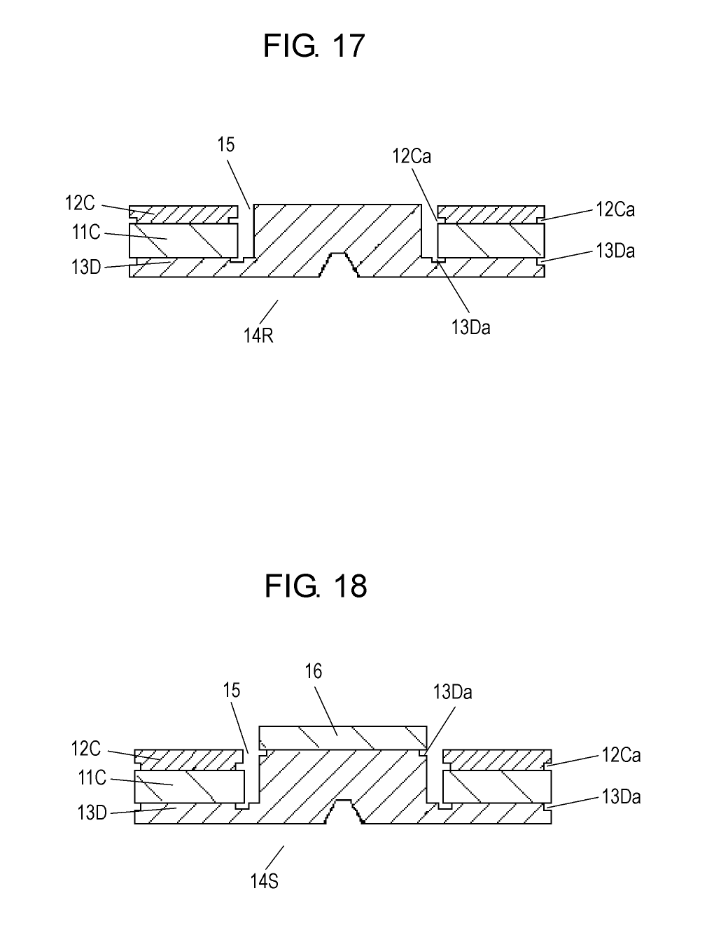

Furthermore, as shown in FIG. 17, the outer diameter of bottom plate 13D is identical to the outer diameter of magnet 11C, in addition to the structure shown in FIG. 16. Recess 13Da is provided in the upper surface of bottom plate 13D at a portion corresponding to the inner side of magnet 11C to configure magnetic circuit 14R for a loudspeaker.

This structure can also provide an escape for the adhesive, similarly to above, thus preventing a gap failure due to a protrusion of the adhesive.

As shown in FIG. 18, repulsion magnet 16 with a different magnetization direction is further provided on the center pole of bottom plate 13D, in addition to the structure shown in FIG. 17. Repulsion magnet 16 is made of a bonded magnet. The outer diameter of repulsion magnet 16 is identical to the outer diameter of the center pole. Recess 13Da is provided in the outer upper surface of the center pole of bottom plate 13D to configure magnetic circuit 14S for a loudspeaker.

This structure can also provide an escape for the adhesive, similarly to above, thus preventing a gap failure due to a protrusion of the adhesive.

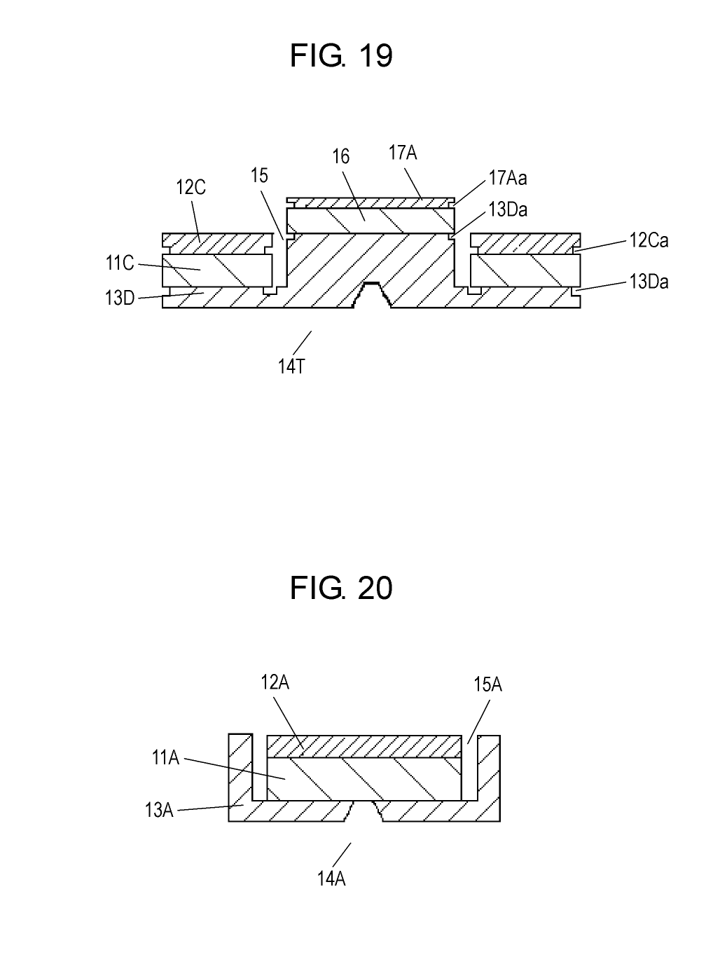

Next, as shown in FIG. 19, sub-plate 17A is provided on repulsion magnet 16, in addition to the structure shown in FIG. 18. The outer diameter of this repulsion magnet 16 is identical to the outer diameter of sub-plate 17A. Recess 17Aa is provided in the outer lower surface of sub-plate 17A to configure magnetic circuit 14T for a loudspeaker.

This structure can provide an escape for the adhesive, similarly to above, thus preventing a gap failure due to a protrusion of the adhesive.

As described above, the structure in which a recess for preventing a protrusion of the adhesive is provided in the top plate, the bottom plate, or the sub-plate can prevent a protrusion of the adhesive and a gap failure similarly to the structure in which a recess is provided in the magnet.

In addition, a plate may not need to be cut in processes, as in a conventional metal material. A mold having a recess is simply used to easily provide a recess by injection-molding, thus improving productivity. A recess may be provided in the top plate, the bottom plate, and the sub-plate by cutting metal material afterward. This provides disadvantages with respect to higher productivity and lighter magnetic circuit. However, this provides advantage with respect to higher magnetic flux density since resin, which is non-magnetic material, is not contained. Accordingly, the way of cutting may be arbitrarily selected depending on required performance and price.

In the above description, the structure of a recess provided in the top plate, the bottom plate, or the sub-plate, so as to prevent a protrusion of the adhesive. Also in the case of melting joint areas of the components for adhesion, the same structure may be adopted to use the recess as an escape for the melted portion.

The recess may be provided in the magnet, the top plate, the bottom plate, or the sub-plate. Still more, the recess may be provided in all of the magnet and the top plate, bottom plate, or sub-plate. With consideration to the amount of the protrusion of the adhesive or the protrusion of the melted portion, the position of the recess may be arbitrarily selected depending on required performance and price.

The above description is for the outer-magnet-type magnetic circuit. An inner-magnet-type magnetic circuit will be described below.

FIG. 20 shows inner-magnet-type magnetic circuit 14A for a loudspeaker in which magnet 11A is sandwiched between top plate 12A and yoke 13A. Magnetic gap 15A is a magnetic space where a voice coil inserted in the gap vertically vibrates upon receiving the magnetic force when magnetic circuit 14A is used in the loudspeaker. This is a part that requires extremely high accuracy.

In this magnetic circuit 14A for a loudspeaker, magnet 11A is made of a bonded magnet, and the outer diameter of top plate 12A is identical to the outer diameter of magnet 11A.

This structure can eliminate a wasted space inside magnetic circuit 14A. In other words, dimensions from the outer diameter of magnet 11A to the inner diameter of yoke 13A can be minimized to improve the magnetic efficiency of magnetic circuit 14A. If magnet 11A is downsized, the outer diameter of top plate 12A and the outer and inner diameters of yoke 13A can be minimized, corresponding to the outer diameter of magnet 11A. Therefore, smaller and lighter magnetic circuit 14A with higher magnetic efficiency can be achieved. In addition, depending on a required shape of magnetic circuit, a thinner, instead of smaller, magnetic circuit can be designed. Furthermore, a smaller and thinner magnetic circuit can be balanced to design a magnetic circuit that satisfies market demands.

Here, magnet 11A is made of a bonded magnet that is a mixture of resin and magnetic material. This can provide a smaller specific gravity than a conventional sintered magnet of rare earth, depending on the proportion of resin mixed. Accordingly, the weight can be drastically reduced.

Dimensional accuracy of magnet 11A made of a bonded magnet will be described below.

Magnet 11A is a bonded magnet, and is obtained by injection-molding a mixture of resin and magnetic material. Accordingly, the dimensional accuracy of this magnet 11A is determined mostly by the dimensional accuracy of molds for injection-molding. Although there are other small variation factors, including pressure and temperature at injection-molding, the dimensional accuracy of the molds is a dominant factor on the whole.

Accordingly, a bonded magnet obtained by increasing the dimensional accuracy of the molds for injection-molding can secure good quality with extremely high dimensional accuracy. The dimensional accuracy is higher than that of rare-earth or ferrite magnet manufactured using a conventional sintering process. Therefore, the outer diameter of top plate 12A can be identical to the outer diameter of magnet 11A by using this high dimensional accuracy.

This is because, in general, the outer diameter of top plate 12A and the inner diameter of yoke 13A are positioned by a gap gauge on assembling magnetic circuit 14A. In addition, this gap gauge extends further to the lower side to simultaneously position the outer diameter of magnet 11A. This can secure a dimension of magnetic gap 15A all the way down, so as to prevent the outer diameter of magnet 11A from projecting into magnetic gap 15A.

This structure can prevent disturbance of vertical vibration of the voice coil in magnetic gap 15A and its lower side when the magnetic circuit is used in a loudspeaker, and also eliminate occurrence of a gap failure.

As described above, a wasted space inside magnetic circuit 14A can be eliminated, magnetic efficiency is improved, and downsizing of magnetic circuit 14A is achieved by allowing the outer diameter of top plate 12A to be identical to the outer diameter of magnet 11A. Accordingly, the present invention can offer a magnetic circuit for a loudspeaker that satisfies the market demand for smaller/thinner and lighter magnetic circuits, and a loudspeaker configured using this magnetic circuit.

The above structure refers to an example in which the outer diameter of top plate 12A is identical to the outer diameter of magnet 11A. To further reduce the size and increase the efficiency, an example in which a repulsion magnet with a different magnetization direction is further provided on the top plate will be described below.

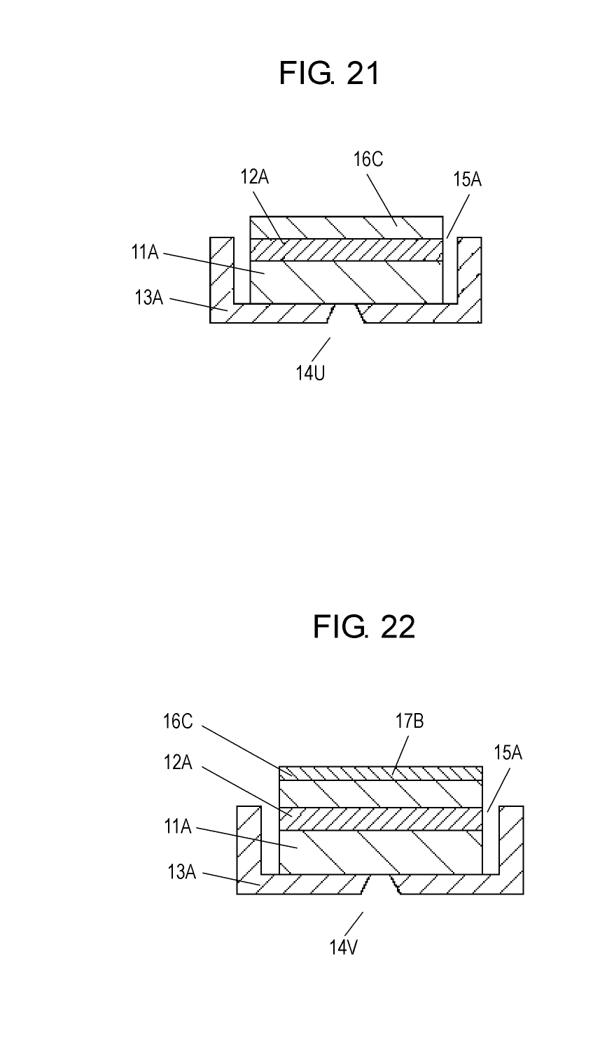

As shown in FIG. 21, repulsion magnet 16C with a different magnetization direction is further provided on top plate 12A. Repulsion magnet 16C is made of a bonded magnet. In addition, the outer diameter of this repulsion magnet 16C is identical to the outer diameter of top plate 12A to configure magnetic circuit 14U for a loudspeaker.

This structure can increase the magnetic flux density in magnetic gap 15A by the effect of repulsion magnet 16C with the different magnetization direction provided on top plate 12A.

To obtain the same magnetic flux density in the magnetic gap, the overall dimensions of the magnetic circuit can thus be reduced.

Accordingly, more efficient and smaller magnetic circuit 14U can be achieved. Still more, when magnetic circuit 14U is used in a loudspeaker, a wasted space inside the loudspeaker surrounded by the upper part of top plate 12A of magnetic circuit 14U, a voice coil, and a dust cap can be eliminated. Furthermore, as shown in FIG. 22, sub-plate 17B may be provided on repulsion magnet 16C. The outer diameter of repulsion magnet 16C may be identical to the outer diameter of sub-plate 17B to configure magnetic circuit 14V for a loudspeaker.

This structure can prevent magnetic flux of repulsion magnet 16C with the different magnetization direction, which is provided on top plate 12A, from leaking in a direction opposite to magnetic gap 15A. Concentrating of the magnetic flux toward magnetic gap 15A can increase the magnetic flux density in magnetic gap 15A. Still more, an operating point of magnetic circuit 14V can be improved. This achieves high quality and high reliability also with respect to ambient temperature characteristics, such as demagnetization at high temperatures and demagnetization at low temperatures.

To obtain the same magnetic flux density in the magnetic gap, the overall dimension of the magnetic circuit can thus be further reduced. Accordingly, further smaller magnetic circuit with further higher magnetic efficiency can be achieved. Furthermore, when magnetic circuit 14V is used in a loudspeaker, a wasted space inside the loudspeaker surrounded by the upper part of top plate 12A of magnetic circuit 14V, a voice coil, and a dust cap can be eliminated.

As described above, the magnetic circuit further including repulsion magnet 16 with the different magnetization direction and sub-plate 17 has a disadvantage with respect to a lighter magnetic circuit since components of repulsion magnet 16 and sub-plate 17 are added, but the magnetic efficiency improves more than this disadvantage. Accordingly, to obtain the same magnetic flux density in the magnetic gap, the magnetic circuit can be made lighter, and the overall dimensions of the magnetic gap can thus be reduced.

Top plate 12A, yoke 13A, and sub-plate 17B used in this magnetic circuit will be described below.

Top plate 12A, yoke 13A, and sub-plate 17B are generally made of metal material, such as iron, as in the prior art. However, these plates and yoke may also be made of a mixture of magnetic material and resin. Top plate 12A, yoke 13A, and sub-plate 17B made by injection-molding the mixture of the magnetic material and the resin can improve the dimensional accuracy, similarly to the aforementioned bonded magnet. In addition, this material provides a smaller specific gravity depending on the proportion of the resin mixed than the plates made of conventional metal material. The weight can thus be drastically reduced.

Accordingly, the combination of top plate 12A, yoke 13A, and sub-plate 17B with aforementioned bonded magnet 11A can drastically reduce the weight of the magnetic circuit. On manufacturing top plate 12A and yoke 13A by injection-molding the mixture of the magnetic material and the resin, a mixing ratio of the magnetic material is higher locally near the outer diameter of top plate 12A or near the inner diameter of yoke 13A than other positions to achieve a magnetic circuit with further higher efficiency. The mixing ratio of magnetic circuit higher locally near top plate 12A and magnetic gap 15A of yoke 13A provides an efficient magnetic circuit. Therefore, to obtain the same magnetic flux density in the magnetic gap, a smaller or thinner magnetic circuit can be achieved. Accordingly, the weight can also be reduced.

A method of coupling the components of these magnetic circuits for a loudspeaker will be described below.

The method of coupling the components configuring the magnetic circuit for a loudspeaker is bonding by adhesive, so as to achieve firm connection. This can provide a good condition with respect to quality and reliability. In this case, an adhesive is preferably selected to firmly adhere the magnetic material with resin.

On the other hand, joint areas of the components may be melted and adhered to configure a magnetic circuit without using an adhesive. In this case, since the joint areas of the components are melted to adhere, an adhesive is not needed, eliminating the thickness of the adhesive, thus providing a thinner magnetic circuit with better magnetic efficiency. The weight of adhesive can also be reduced. Ultrasonic waves may be used for heating and melting, hence providing the magnetic circuit at good productivity. Alternatively, solvent may be used for melting to adhere. This can eliminate a heat source, such as the ultrasonic waves, and the method of adhering the magnetic circuit that is also advantageous costwise, such as equipment and electric energy costs, in addition to good productivity.

As described above, the magnetic circuit configured by melting and adhering the joint areas of the components without using an adhesive can provide a significant synergetic effect by also configuring a part or all of the magnet, the top plate, the yoke, and the sub-plate which are components of the magnetic circuit with a mixture of magnetic metal and resin. This can contribute to a further smaller magnetic circuit with further higher magnetic efficiency and productivity.

An advantageous structure when adhering the components of the magnetic circuit for a loudspeaker by an adhesive or melting the joint areas of the components will be described below.

In the case of bonding by adhesive or melting the joint areas of the components, the dimensional accuracy or quality can be improved by preventing a protrusion of the adhesive or a protrusion of the melted portion from the joint areas.

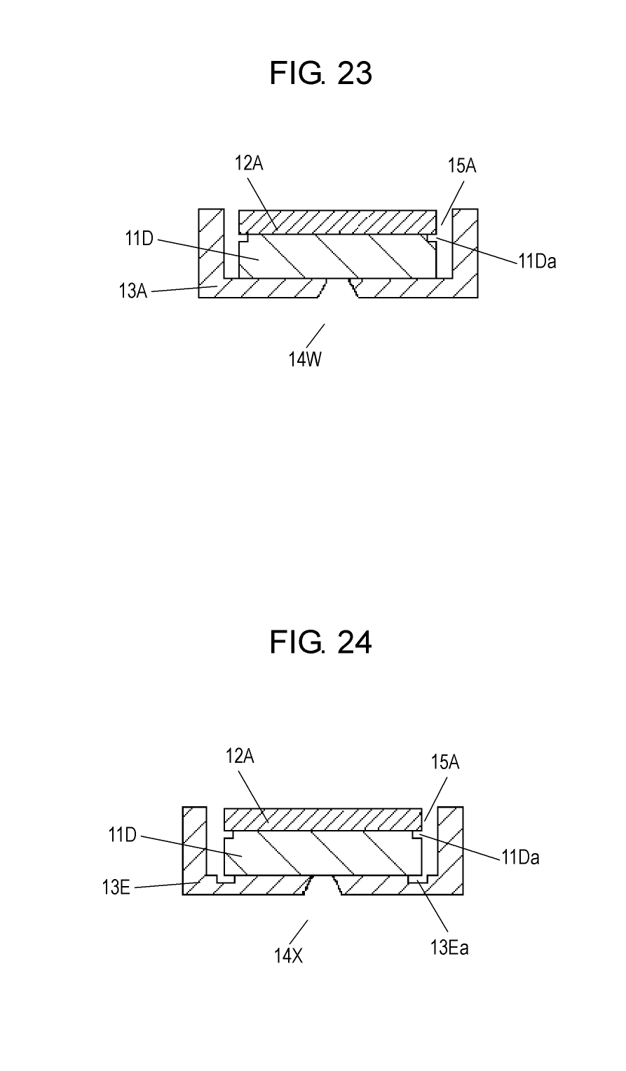

FIGS. 23 to 29 are sectional views of magnetic circuits for a loudspeaker according to the embodiment of the invention.

In FIG. 23, magnet 11D is sandwiched between top plate 12A and yoke 13A to configure inner-magnet-type magnetic circuit 14W for a loudspeaker. Magnetic gap 15A is a magnetic space where a voice coil inserted therein vertically vibrates upon receiving magnetic force when this magnetic circuit 14W is used in a loudspeaker. This is a part that requires extremely high accuracy. In this magnetic circuit 14W for a loudspeaker, magnet 11D is made of a bonded magnet. The outer diameter of top plate 12A is identical to the outer diameter of magnet 11D. In addition, recess 11Da is provided in magnet 11D.

This structure eliminates a wasted space inside magnetic circuit 14W. In other words, a distance from the outer diameter of magnet 11D to the inner diameter of yoke 13A can be reduced as much as possible to improve the magnetic efficiency of magnetic circuit 14W. In addition, recess 11Da is provided in magnet 11D. Recess 11Da provides an escape for an excessive adhesive protruding into magnetic gap 15A. The protrusion of the adhesive to magnetic gap 15A can thus be prevented, reducing a gap failure.

In other words, for bonding magnet 11D and top plate 12A with adhesive, recess 11Da in magnet 11D at the upper part near the outer circumference provides an escape for the adhesive. An excessive adhesive is collected in recess 11Da, and thus the adhesive does not project into magnetic gap. A gap failure due to the protrusion of the adhesive can thus be prevented. To provide magnet 11D with a small size, the outer diameter of top plate 12A and the inner and outer diameters of yoke 13A can be reduced as much as possible to be flush with the outer diameter of magnet 11D. Accordingly, smaller and lighter magnetic circuit 14W with high magnetic efficiency can be achieved. Still more, a thinner, instead of smaller, magnetic circuit can be designed depending on a required shape of magnetic circuit. Furthermore, smaller and thinner magnetic circuit can be balanced to design a magnetic circuit that satisfies market demands.

Magnet 11D made of a bonded magnet made of a mixture of resin and magnetic metal can provide a smaller specific gravity than a conventional sintered rare-earth magnet, depending on the proportion of resin mixed. Significantly lighter magnet 11D can thus be achieved.

The above example having recess 11Da in magnet 11D on the joint portion at the upper part near the outer circumference of magnet 11D are described. However, the position to recess 11Da is not limited to this position. Recess 11Da can be provided in any position of magnet 11D where the adhesive may protrude.

A dimensional accuracy of magnet 11D, which is a bonded magnet, will be described below. Magnet 11D is a bonded magnet, and is obtained by injection-molding a mixture material of resin and magnetic material. Accordingly, the dimensional accuracy of magnet 11D is determined mostly on the dimensional accuracy of molds for injection-moldings. Although there are other small variation factors, such as pressure and temperature at injection-molding, the dimensional accuracy of molds is a dominant factor on the whole. Therefore, the bonded magnet can ensure good quality with extremely high dimensional accuracy by increasing the dimensional accuracy of molds for injection-molding. Far higher dimensional accuracy is thus achieved, compared to that of rare-earth or ferrite magnet made using the conventional sintering process. Accordingly, as described above, the outer diameter of top plate 12A can be identical to the outer diameter of magnet 11D by using this high dimensional accuracy.

This is because, in general, the outer diameter of top plate 12A and the inner diameter of yoke 13A are positioned by a gap gauge on assembling magnetic circuit 14W. In addition, this gap gauge further extends to the lower side simultaneously to position the outer diameter of magnet 11D. This can secure the dimension of magnetic gap 15A all the way down, so as to prevent the outer circumference of magnet 11D from projecting into magnetic gap 15A. This structure can prevent disturbance of vertical vibration of the voice coil in magnetic gap 15A and its lower side when the magnetic circuit 14W is used in a loudspeaker, and also eliminate occurrence of gap failure.

As described above, a wasted space inside magnetic circuit 14A can be eliminated by allowing the outer diameter of top plate 12A to be identical to the outer diameter of magnet 11D. This can provide smaller magnetic circuit 14W with higher magnetic efficiency. Accordingly, the present invention can offer a magnetic circuit for a loudspeaker that satisfies the market demand for smaller/thinner and lighter magnetic circuits, and a loudspeaker configured using this magnetic circuit.

An example having providing a recess in a different part will be described below.

FIG. 24 shows magnetic circuit 14X for a loudspeaker in which a recess is provided in yoke 13E. Recess 13Ea in the yoke near the outer circumference of the bonded part of magnet 11D and yoke 13E prevents a protrusion of an adhesive used for bonding magnet 11D and yoke 13E at the lower side of magnetic gap 15A. This structure can also prevent a protrusion of the adhesive at the lower side of magnetic gap 15A, thus reducing a gap failure.

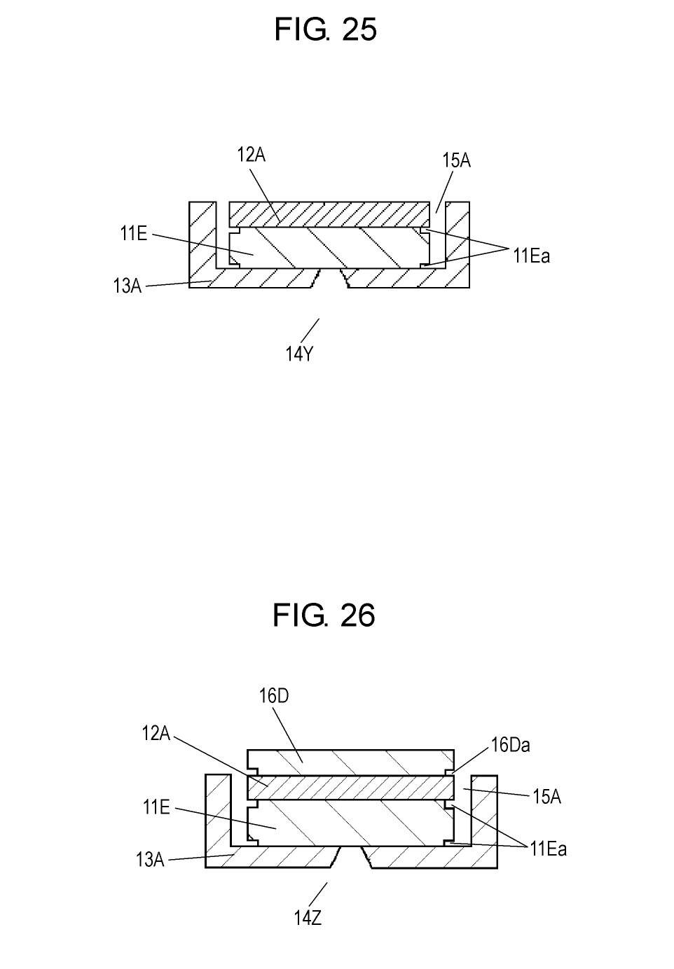

In addition, as shown in FIG. 25, recess 11Ea may be provided in the lower side of magnet 11E near the outer circumference of a bonded part of magnet 11E and yoke 13A to prevent a protrusion of an adhesive at the lower side of magnetic gap 15A in the structure of magnetic circuit 14Y for a loudspeaker. This structure can prevent a protrusion of the adhesive also at the lower side of magnetic gap 15A, hence reducing a gap failure.

An example in which a repulsion magnet with a different magnetization direction is further provided on the top plate, so as to further downsize and increase the efficiency will be described below.

As shown in FIG. 26, repulsion magnet 16D with a different magnetization direction is further provided on top plate 12A. Repulsion magnet 16D is made of a bonded magnet. The outer diameter of repulsion magnet 16D is identical to the outer diameter of top plate 12A. Recess 16Da is also provided on repulsion magnet 16D to configure magnetic circuit 14Z for a loudspeaker. This structure can increase the magnetic flux density in magnetic gap 15A by the effect of repulsion magnet 16D with the different magnetization direction provided on top plate 12A. Recess 16Da in repulsion magnet 16D can collect the adhesive in recess 16Da when the adhesive protrudes. A protrusion of the adhesive protruding to magnetic gap 15A can thus be prevented, reducing a gap failure.

Accordingly, to obtain the same magnetic flux density in the magnetic gap, the overall dimensions of the magnetic circuit can be reduced. Higher magnetic efficiency and smaller magnetic circuit 14Z can be achieved. When magnetic circuit 14Z is used in a loudspeaker, a wasted space inside the loudspeaker surrounded by top plate 12A of magnetic circuit 14Z, a voice coil, and a dust cap can be eliminated.

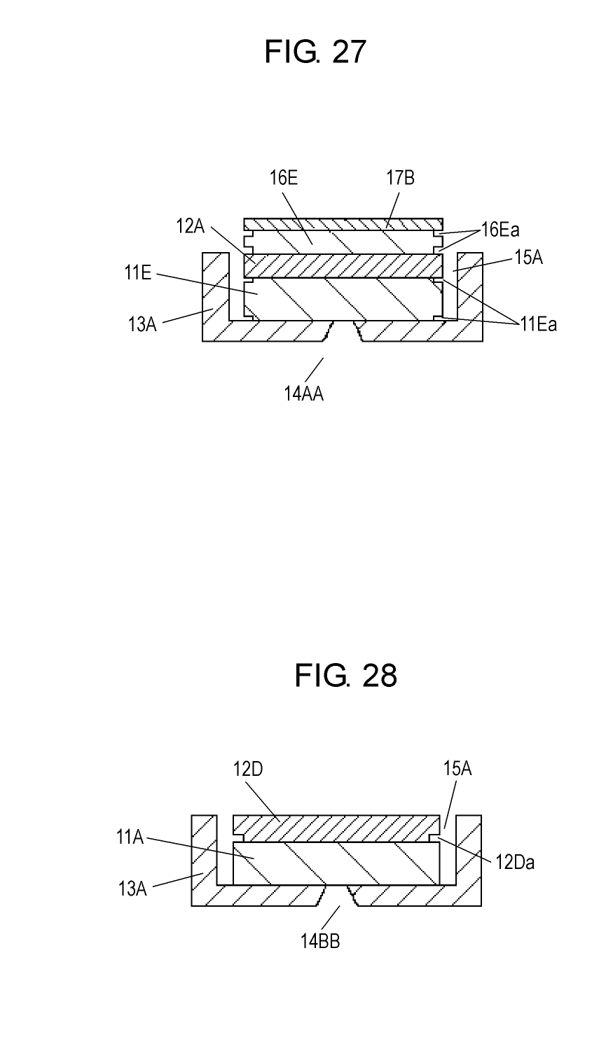

Furthermore, as shown in FIG. 27, sub-plate 17B is further provided on repulsion magnet 16E. The outer diameter of this repulsion magnet 16E is identical to the outer diameter sub-plate 17B to configure magnetic circuit 14AA for a loudspeaker. This prevents magnetic flux of repulsion magnet 16E with the different magnetization direction, which is provided on top plate 12A, from leaking in the direction opposite to magnetic gap 15A. Magnetic flux is thus concentrated toward magnetic gap 15A. This effect can further increase the magnetic flux density in magnetic gap 15A. In addition, since the operating point of magnetic circuit 14AA can be improved, higher quality and higher reliability can be achieved with respect to ambient temperature characteristics, such as demagnetization at high temperatures and demagnetization at low temperatures. Furthermore, recess 16Ea is provided near the outer circumference of the bonded part of repulsion magnet 16E and sub-plate 17B. Recess 16Ea provides an escape for an excessive adhesive protruding to magnetic gap 15A. A protrusion of the adhesive protruding to magnetic gap 15A can thus be prevented, reducing a gap failure. Accordingly, to obtain the same magnetic flux density in the magnetic gap, overall dimensions of the magnetic circuit can be further reduced. Further higher magnetic efficiency and further smaller magnetic circuit 14AA can thus be achieved. When magnetic circuit 14AA is used in a loudspeaker, a wasted space inside the loudspeaker surrounded by the upper part of top plate 12A, a voice coil, and a dust cap can be eliminated.

As described above, the magnetic circuit further including the repulsion magnet with a different magnetization direction and the sub-plate is disadvantageous with respect to a lighter magnetic circuit since components of the repulsion magnet and the sub-plate are added. However, the magnetic efficiency improves more than disadvantage. Therefore, to obtain the same magnetic flux density in the magnetic gap, a lighter magnetic circuit can be achieved. Accordingly, overall dimensions of the magnetic circuit can be reduced.

As described above, the top plate, the yoke, and the sub-plate are generally made of conventional metal material, such as iron. However, a mixture of magnetic material and resin may also be used for the plates and yoke.

The top plate, the yoke, and the sub-plate formed by injection-molding the mixture of the magnetic material and the resin can improve the dimensional accuracy, similarly to the aforementioned bonded magnet. In addition, the specific gravity can be reduced depending on the proportion of resin mixed, compared to plates formed of conventional metal material. The weight can thus be drastically reduced. Accordingly, the magnetic circuit can be made drastically lighter by combining the top plate, the yoke, and the sub-plate with aforementioned bonded magnet.

As shown in FIG. 28, recess 12Da may be provided in top plate 12D near the outer circumference of a joint area of top plate 12D and magnet 11A to configure magnetic circuit 14 for a loudspeaker. In this structure, recess 12Da provides an escape for an excessive adhesive, and thus a protrusion of the adhesive protruding to magnetic gap 15A can be prevented. Accordingly, a gap failure can be reduced. In addition, recess 12Da does not need to be cut in a manufacturing process, which is the case of plates made of conventional metal material. Recess 12Da can be easily provided by using molds for injection molding having a recess, accordingly increasing productivity.

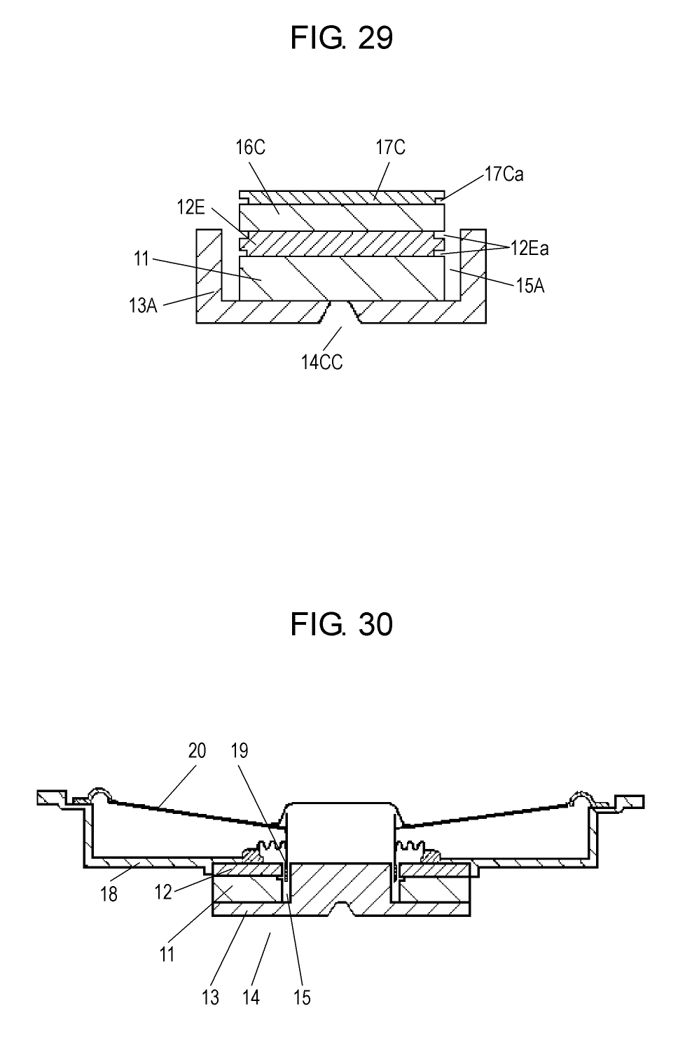

Furthermore, as shown in FIG. 29, recess 12EA may be provided in top plate 12E near the outer circumference of a joint area of top plate 12E and repulsion magnet 16C to configure magnetic circuit 14CC for a loudspeaker. In addition, recess 17Ca may be provided in top plate 12E near the outer circumference of a joint area of sub-plate 17C and repulsion magnet 16C. In this structure, recesses 12Ea and 17Ca can provide escapes for an excessive adhesive, and thus a protrusion of the adhesive protruding to magnetic gap 15a can be prevented, reducing a gap failure.

As described above, a magnetic circuit configured by melting and adhering joint areas of the components, without using an adhesive, provides a significant synergetic effect by also configuring a part or all of the magnet, the top plate, the yoke, and the sub-plate; which are components of the magnetic circuit, with a mixture of magnetic material and resin. This greatly contributes to further higher magnetic efficiency, thinner magnetic circuit, and higher productivity. Recesses provided in the bonded magnet, the top plate, the yoke, and the sub-plate can provide escapes for melted portions when the above components are melted and adhered, in addition to escapes for an adhesive. Accordingly, a protrusion of the melted portions to protruding the magnetic gap can be prevented, reducing a gap failure.

The above describes about the magnetic circuit for a loudspeaker. A loudspeaker using this magnetic circuit for a loudspeaker will be described below.

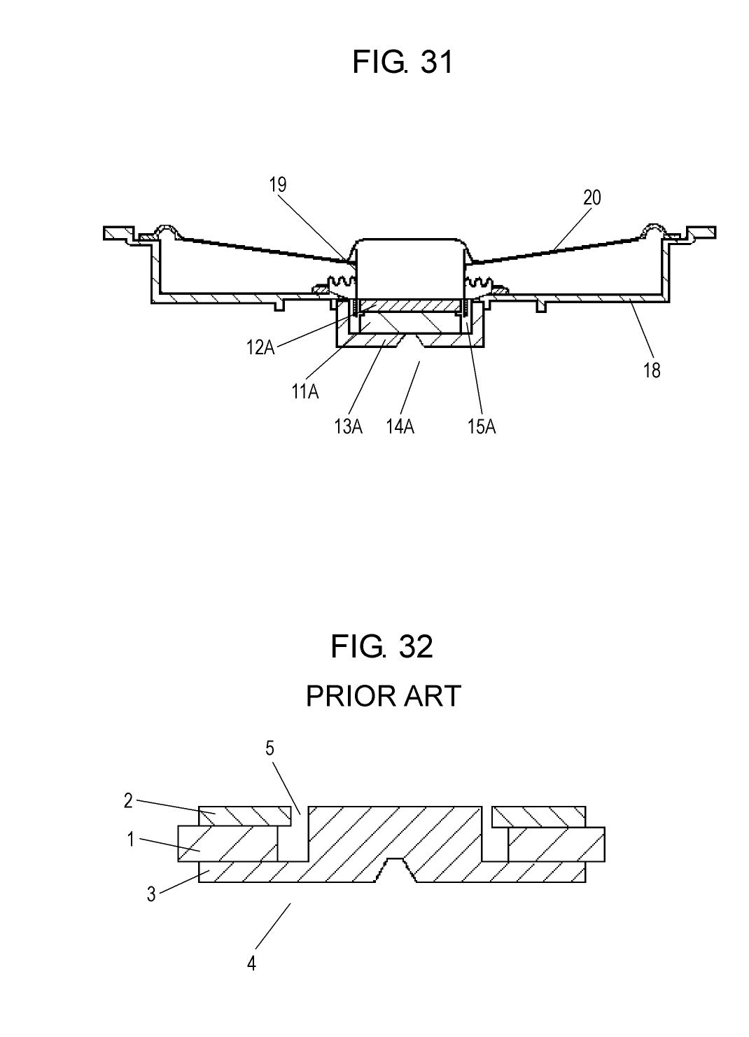

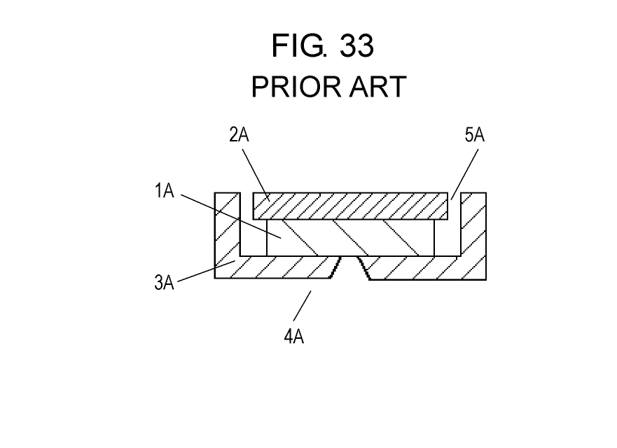

FIG. 30 is a sectional view of an outer-magnet-type loudspeaker according to the embodiment of the invention. FIG. 31 is a sectional view of an inner-magnet-type loudspeaker.

In the outer-magnet-type loudspeaker, as shown in FIG. 30, magnet 11 is sandwiched between top plate 12 and bottom plate 13 to configure magnetic circuit 14 for the outer type magnet loudspeaker. Frame 18 is connected to magnetic circuit 14. Diaphragm 20 having an outer periphery coupled to the outer circumference of frame 18 is connected to voice coil 19 inserted in magnetic gap 15 of magnetic circuit 14 to configure the loudspeaker.

On the other hand, in the inner magnet type loudspeaker, as shown in FIG. 31, magnet 11A is sandwiched between top plate 12A and yoke 13A to configure magnetic circuit 14A for the inner type magnet loudspeaker. Frame 18 is connected to magnetic circuit 14A. Diaphragm 20 having an outer periphery coupled to the outer circumference of frame 18 is connected to voice coil 19 inserted in magnetic gap 15A of magnetic circuit 14A to configure the loudspeaker.

An aforementioned recess may be provided in a part of components of magnetic circuit 14 and magnetic circuit 14A.

As described above, in the magnetic circuits for a loudspeaker according to the embodiment, the magnet and the top plate are configured to satisfy at least one of conditions that an inner diameter of the magnet is identical to an inner diameter of the top plate, and that an outer diameter of the magnet is identical to an outer diameter of the top plate.

The above structure can achieve a smaller, thinner and lighter loudspeaker. In addition, a protrusion of an adhesive and a gap failure can be prevented. Accordingly, the loudspeaker that can satisfy market demands for quality can also be achieved, in addition to demands for the smaller, thinner, and lighter loudspeakers.

### INDUSTRIAL APPLICABILITY

The present invention is effectively applicable to magnetic circuits for loudspeakers and loudspeakers that require downsizing, thinning, and weight reduction.

### REFERENCE MARKS IN THE DRAWINGS

1, 1A Magnet
2, 2A Top Plate
3 Bottom Plate
3A Yoke
4, 4A Magnetic Circuit
5, 5A Magnetic Gap
11, 11A, 11B, 11C, 11D, 11E Magnet
11Da, 11Ea, 11Fa, 11Ga Recess
12, 12A, 12B, 12C, 12D, 12E Top Plate
12Ba, 12Ca Recess
13, 13B, 13C, 13D Bottom Plate
13A, 13E Yoke
13Ca, 13Da, 13Ea Recess
14, 14A, 14B, 14C, 14D, 14E, 14F, 14G, 14H, 14J, 14K, 14L, 14M, 14N, 14P, 14Q, 14R, 14S, 14T, 14U, 14V, 14W, 14X, 14Y, 14Z, 14AA, 14BB, 14CC Magnetic Circuit
15, 15A Magnetic Gap
16, 16A, 16B, 16C, 16D, 16E Repulsion Magnet
16Aa, 16Ba, 16Da, 16Ea Recess
17, 17A, 17B, 17C Sub-Plate
17Aa, 17Ca Recess
18 Frame
19 Voice Coil
20 Diaphragm

1. A magnetic circuit for a loudspeaker, comprising:
a magnet made of a bonded magnet; and
a top plate,
wherein the magnet and the top plate are configured to satisfy at least one of conditions:
that an inner diameter of the magnet is identical to an inner diameter of the top plate; and
that an outer diameter of the magnet is identical to an outer diameter of the top plate.

2. The magnetic circuit according to claim 1, further comprising
a bottom plate,
wherein the magnetic circuit is an outer-magnet-type magnetic circuit in which the magnet sandwiched between the top plate and the bottom plate.

3. The magnetic circuit according to claim 1, further comprising
a yoke,
wherein the magnetic circuit is an inner-magnet-type magnetic circuit in which the magnet sandwiched between the top plate and the yoke.

4. The magnetic circuit according to claim 1, further comprising
one of a bottom plate and a yoke,
wherein a recess is provided in at least one of the magnet, the top plate, and said at least one of the bottom plate and the yoke.

5. The magnetic circuit according to claim 1, further comprising
a repulsion magnet with a magnetization direction from a magnetization direction of the magnet,
wherein the repulsion magnet is made of a bonded magnet.

6. The magnetic circuit according to claim 5, wherein an outer diameter of the repulsion magnet is identical to an outer diameter of one of the magnet and the top plate which are components of the magnetic circuit where the repulsion magnet is attached.

7. The magnetic circuit according to claim 5, further comprising
a sub-plate provided on top of the repulsion magnet,
wherein an outer diameter of the repulsion magnet is identical to an outer diameter of the sub-plate.

8. The magnetic circuit according to claim 5, further comprising
a bottom plate,
wherein an outer diameter of the repulsion magnet is identical to an outer diameter of the bottom plate where the repulsion magnet is attached.

9. The magnetic circuit according to claim 8, further comprising
a sub-plate provided on top of the repulsion magnet,
wherein an outer diameter of the repulsion magnet is identical to an outer diameter of the sub-plate.

10. The magnetic circuit according to claim 5, wherein a recess is provided in the repulsion magnet.

11. The magnetic circuit according to claim 7, wherein a recess is provided in the sub-plate.

12. The magnetic circuit according to claim 1, wherein the top plate is made of a mixture of magnetic metal and resin.

13. The magnetic circuit according to claim 2, wherein the bottom plate is made of a mixture of magnetic metal and resin.

14. The magnetic circuit according to claim 3, wherein the yoke is made of a mixture of magnetic metal and resin.

15. The magnetic circuit according to claim 7, wherein the sub-plate is made of a mixture of magnetic metal and resin.

16. The magnetic circuit according to claim 5, wherein a recess is provided in the repulsion magnet.

17. The magnetic circuit according to claim 7, wherein a recess is provided in the sub-plate.

18. The magnetic circuit according to claim 12,
wherein the magnetic circuit has a magnetic gap,
wherein one of the magnet and the top plate is a component of the magnetic circuit which contains magnetic metal, and
a mixing ratio of the magnetic metal in the magnetic circuit is higher locally near the magnetic gap than other positions of the component.

19. The magnetic circuit according to claim 13,
wherein the magnetic circuit has a magnetic gap,
wherein one of the magnet and the bottom plate is a component of the magnetic circuit which contains magnetic metal, and
a mixing ratio of the magnetic metal in the component of the magnetic circuit is higher locally near the magnetic gap than other positions of the component.

20. The magnetic circuit according to claim 14,
wherein the magnetic circuit has a magnetic gap,
wherein one of the magnet and the yoke is a component of the magnetic circuit which contains magnetic metal, and
wherein a mixing ratio of the magnetic metal in the component of the magnetic circuit is larger locally near the magnetic gap than other positions of the component.

21. The magnetic circuit according to claim 1, wherein the component of the magnetic circuit is bonded with an adhesive.

22. The magnetic circuit according to claim 1, wherein the component of the magnetic circuit is melted and attached by melting a joint area of the component.

23. The magnetic circuit according to claim 22, wherein the component of the magnetic circuit is melted and attached by thermally melting the joint area of the component.

24. The magnetic circuit according to claim 22, wherein the component of the magnetic circuit is melted and attached by melting the joint area of the component by solvent.

25. A loudspeaker comprising:
a magnetic circuit including
a magnet made of a bonded magnet, and
a top plate,
wherein the magnet and the top plate are configured to satisfy at least one of conditions
that an inner diameter of the magnet is identical to an inner diameter of the top plate have, and
that an outer diameter of the magnet is identical to an outer diameter of the top plate;
a frame coupled to the magnetic circuit;
a voice coil inserted in a magnetic gap of the magnetic circuit; and
a diaphragm coupled to the voice coil, the diaphragm having an outer periphery coupled to an outer circumference of the frame.
